(19) United States
(12) Patent Application Publication
(10) Pub. No.: US 2024/0118867 A1
(43) Pub. Date: Apr. 11, 2024

(54) METHOD FOR DIGITAL TWIN BASED DATA MERGING

(71) Applicant: PricewaterhouseCoopers LLP, New York, NY (US)

(72) Inventors: Zhen QI, Johns Creek, GA (US); Xingyi YU, Shanghai (CN); Samuel Pierce BURNS, Philadelphia, PA (US); Sierra HAWTHORNE, San Luis Obispo, CA (US); Shannon SMITH, Kansas City, MO (US); Joseph David VOYLES, Louisville, KY (US); Anand Srinivasa RAO, Boston, MA (US)

(73) Assignee: PricewaterhouseCoopers LLP, New York, NY (US)

(21) Appl. No.: 17/937,442

(22) Filed: Sep. 30, 2022

(51) Int. Cl. G06F 7/14; G06F 16/2457

(52) U.S. Cl. CPC G06F 7/14; G06F 16/24578

(57) ABSTRACT

Disclosed herein are methods and systems for generating a merged dataset, comprising: accessing data comprising a core dataset and an additional dataset; identifying a plurality of common attributes between the core dataset and the additional dataset; determining a plurality of similarity scores between an inquiring entity in the core dataset and a plurality of candidate entities in the additional dataset, including, for each candidate entity of the plurality of candidate entities: calculating a similarity score for the candidate entity based at least in part on a distance-based score and a weight influence score; selecting one or more matches for the inquiring entity in the core dataset from the plurality of candidate entities in the additional dataset based at least in part on the plurality of similarity scores; and generating the merged dataset by adding the one or more selected matches for the inquiring entity to the core dataset.

### FIELD

This disclosure relates generally to data merging algorithms, and more specifically to digital twin-based data merging algorithms.

### BACKGROUND

Data merging is useful for combining multiple datasets with different attributes to gain insights as to how attributes may relate to one another. Traditionally, two or more datasets comprise one or more identical identifiers, thus allowing for direct data merging. However, in the instance the data to be merged is from different data sources or describes different sets of individuals, an identical identifier may not exist and thus direct merging is not possible. Synthetic data created by merging datasets has recently grown in importance in the field of artificial intelligence (AI), with known applications in generating use cases to scale and train models.

### SUMMARY

There is a need for a method to merge datasets which do not share an identical identifier. The disclosed digital twin-based data merging algorithm may use a set of common attributes to evaluate the similarity between an inquiring entity in a core dataset and candidate entities in one or more additional datasets. Each candidate entity in the additional datasets may be assigned a sample weight which may also contribute to the similarity evaluated between the inquiring entity and the candidate entity. The similarities may be assessed to determine one or more matches from the candidate entities in the additional dataset, and the selected matches may be analyzed using, for example, satisfaction criteria and a similarity score threshold, prior to creating a merged dataset with the inquiring entity and matches. Additionally, the system may evaluate one or more statistics related to the performance of merging between the core dataset and additional datasets, such as the distribution and confidence of the matching results. Merging datasets provides comprehensive coverage of all the attributes of interest between the datasets, thus providing a reliable data foundation for analytics, modeling, and prediction.

In some embodiments, a method for generating a merged dataset is provided, the method comprising: accessing data comprising a core dataset and an additional dataset; identifying a plurality of common attributes between the core dataset and the additional dataset; determining a plurality of similarity scores between an inquiring entity in the core dataset and a plurality of candidate entities in the additional dataset, including, for each candidate entity of the plurality of candidate entities: calculating a distance-based score for the candidate entity based at least in part on one or more of the plurality of identified common attributes; calculating a weight influence score for the candidate entity based at least in part on a weight assigned to the candidate entity; and calculating a similarity score for the candidate entity based at least in part on the distance-based score and the weight influence score; selecting one or more matches for the inquiring entity in the core dataset from the plurality of candidate entities in the additional dataset based at least in part on the plurality of similarity scores; and generating the merged dataset by adding the one or more selected matches for the inquiring entity to the core dataset.

In some embodiments, the method comprises, prior to determining the plurality of similarity scores, evaluating the plurality of common attributes to determine that the plurality of identified common attributes satisfies one or more predefined criteria.

In some embodiments, one or more of the predefined criteria are related to an expected performance of a given attribute and/or an appropriate number of common attributes.

In some embodiments, generating the merged dataset includes determining that one or more of the calculated similarity scores between the inquiring entity and the plurality of candidate entities in the additional dataset exceeds a predefined score threshold.

In some embodiments, the method comprises, prior to generating the merged dataset, evaluating the confidence and/or distribution of the one or more selected matches for the inquiring entity.

In some embodiments, the core dataset is accessed via a first data source and the additional dataset is accessed via a second data source.

In some embodiments, the core dataset and additional dataset do not share an identical identifier for direct dataset merging.

In some embodiments, the additional dataset is a subset of a superset, and wherein the weight assigned to the candidate entity in the subset is based on representativeness of a group of similar entities in the superset.

In some embodiments, calculating the distance-based score is based on a weighted Manhattan distance.

In some embodiments, calculating the weight influence score includes normalization and bounding the weight assigned to the candidate entity with at least one cropping function.

In some embodiments, the weight influence score is based on a size of the additional dataset.

In some embodiments, the method comprises validating the merged dataset using one or more of: internal validation and external validation.

In some embodiments, the method comprises applying the merged dataset to one or more of: a data analytics operation, an artificial intelligence (AI) model training operation, a model diagnosis operation, and a model evaluation technique.

In some embodiments, a non-transitory computer-readable storage medium storing one or more programs for generating a merged dataset is provided, the programs for execution by one or more processors of an electronic device that when executed by the device, cause the device to: access data comprising a core dataset and an additional dataset; identify a plurality of common attributes between the core dataset and the additional dataset; determine a plurality of similarity scores between an inquiring entity in the core dataset and a plurality of candidate entities in the additional dataset, including, for each targeted individual of the plurality of candidate entities: calculate a distance-based score for the targeted individual based at least in part on one or more of the plurality of identified common attributes; calculate a weight influence score for the targeted individual based at least in part on a weight assigned to the targeted individual; and calculate a similarity score for the targeted individual based at least in part on the distance-based score and the weight influence score; select one or more matches for the inquiring entity in the core dataset from the plurality of candidate entities in the additional dataset based at least in part on the plurality of similarity scores; and generate the merged dataset by adding the one or more selected matches for the inquiring entity to the core dataset.

In some embodiments, a system for generating a merged dataset is provided, the system comprising: one or more processors; memory; and one or more programs stored on the memory that when executed by the one or more processors cause the one or more processors to: access data comprising a core dataset and an additional dataset; identify a plurality of common attributes between the core dataset and the additional dataset; determine a plurality of similarity scores between an inquiring entity in the core dataset and a plurality of candidate entities in the additional dataset, including, for each targeted individual of the plurality of candidate entities: calculate a distance-based score for the targeted individual based at least in part on one or more of the plurality of identified common attributes; calculate a weight influence score for the targeted individual based at least in part on a weight assigned to the targeted individual; and calculate a similarity score for the targeted individual based at least in part on the distance-based score and the weight influence score; select one or more matches for the inquiring entity in the core dataset from the plurality of candidate entities in the additional dataset based at least in part on the plurality of similarity scores; and generate the merged dataset by adding the one or more selected matches for the inquiring entity to the core dataset.

In some embodiments, a method for generating a merged dataset is provided, the method comprising: accessing data comprising a core dataset and a plurality of additional datasets; determining ranking data of the plurality of additional datasets; selecting a first additional dataset of the plurality of additional datasets based on the ranking data; identifying a plurality of common attributes between the core dataset and the first additional dataset; in accordance with determining that the plurality of identified common attributes satisfy one or more predefined criteria, selecting one or more matches for each inquiring entity in the core dataset from a plurality of candidate entities in the first additional dataset; and generating the merged dataset by adding the one or more selected matches to the core dataset.

In some embodiments, in accordance with determining that the plurality of common attributes between the core dataset and the first additional dataset do not satisfy the one or more predefined criteria, the method comprises modifying the ranking data of the plurality of additional datasets.

In some embodiments, the method comprises: selecting a second additional dataset of the plurality of additional datasets based on the modified ranking data; and identifying a plurality of common attributes between the core dataset and the second additional dataset.

In some embodiments, in accordance with determining that the second plurality of identified common attributes satisfies the one or more predefined criteria, the method comprises selecting one or more matches for each inquiring entity in the core dataset from a plurality of candidate entities in the second additional dataset.

In some embodiments, the method comprises generating the merged dataset by adding the one or more selected matches to the core dataset.

In some embodiments, selecting the one or more matches for each inquiring entity in the core dataset comprises determining a plurality of similarity scores between the inquiring entity and each targeted individual of the plurality of candidate entities in the first additional dataset.

In some embodiments, determining a similarity score for the targeted individual of the plurality of candidate entities is based at least in part on a distance-based score calculated based at least in part on one or more of the plurality of identified common attributes between the core dataset and the first additional dataset.

In some embodiments, determining a similarity score for a given individual of the plurality of candidate entities is based at least in part on a weight influence score calculated based at least in part on a weight assigned to the targeted individual.

In some embodiments, a non-transitory computer-readable storage medium storing one or more programs for generating merged datasets is provided, the programs for execution by one or more processors of an electronic device that when executed by the device, cause the device to: access data comprising a core dataset and a plurality of additional datasets; determine ranking data of the plurality of additional datasets; selecting a first additional dataset of the plurality of additional datasets based on the ranking data; identify a plurality of common attributes between the core dataset and the first additional dataset; in accordance with determining that the plurality of identified common attributes satisfy one or more predefined criteria, select one or more matches for each inquiring entity in the core dataset from a plurality of candidate entities in the first additional dataset; and generate the merged dataset by adding the one or more selected matches to the core dataset.

In some embodiments, a system for generating merged datasets is provided, the system comprising: one or more processors; memory; and one or more programs stored on the memory that when executed by the one or more processors cause the one or more processors to: access data comprising a core dataset and a plurality of additional datasets; determine ranking data of the plurality of additional datasets; select a first additional dataset of the plurality of additional datasets based on the ranking data; identify a plurality of common attributes between the core dataset and the first additional dataset; in accordance with determining that the plurality of identified common attributes satisfy one or more predefined criteria, select one or more matches for each inquiring entity in the core dataset from a plurality of candidate entities in the first additional dataset; and generate the merged dataset by adding the one or more selected matches to the core dataset.

### BRIEF DESCRIPTION OF THE FIGURES

The invention will now be described, by way of example only, with reference to the accompanying drawings, in which:

FIGS. 1A-1B show a process diagram for generating a merged dataset from a core dataset and an additional dataset, in accordance with some embodiments.

FIG. 2 shows an illustrative overview of a digital twin-based merging algorithm, in accordance with some embodiments.

FIG. 3 shows a method for generating a merged dataset from a core dataset and an additional dataset, in accordance with some embodiments.

FIG. 4 shows a system for executing a digital twin-based merging algorithm, in accordance with some embodiments.

FIG. 5 shows a device for implementing a digital twin-based merging algorithm, in accordance with some embodiments.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Disclosed herein are methods and systems for merging datasets using a set of common attributes. The method includes accessing data from one or more data sources comprising a core dataset and one or more additional datasets, identifying common attributes between the core dataset and an additional dataset, determining a plurality of similarity scores between an inquiring entity in the core dataset and one or more candidate entities in the additional dataset, selecting one or more matches from the additional dataset based on the plurality of similarity scores, and generating a merged dataset with the inquiring entity from the core dataset and the selected matches. Whether the plurality of similarity scores is determined for a given additional dataset may be dependent on the identified common attributes satisfying one or more predetermined criteria. In instances in which multiple additional datasets exist, the algorithm may be iterated by first being applied to a first additional dataset to generate a merged dataset, and thereafter being iteratively applied (e.g., starting with the most recent merged dataset) to one or more additional datasets; the most recent version of the merged dataset can thus be iteratively updated based on further additional datasets. The digital twin-based merging algorithm may be applied in various industries, such as healthcare, finance, and insurance to gain meaningful insights to the relationship between attributes describing different entities without a key identifier.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The present disclosure in some embodiments relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

### Process for Digital-Twin Based Data Merging

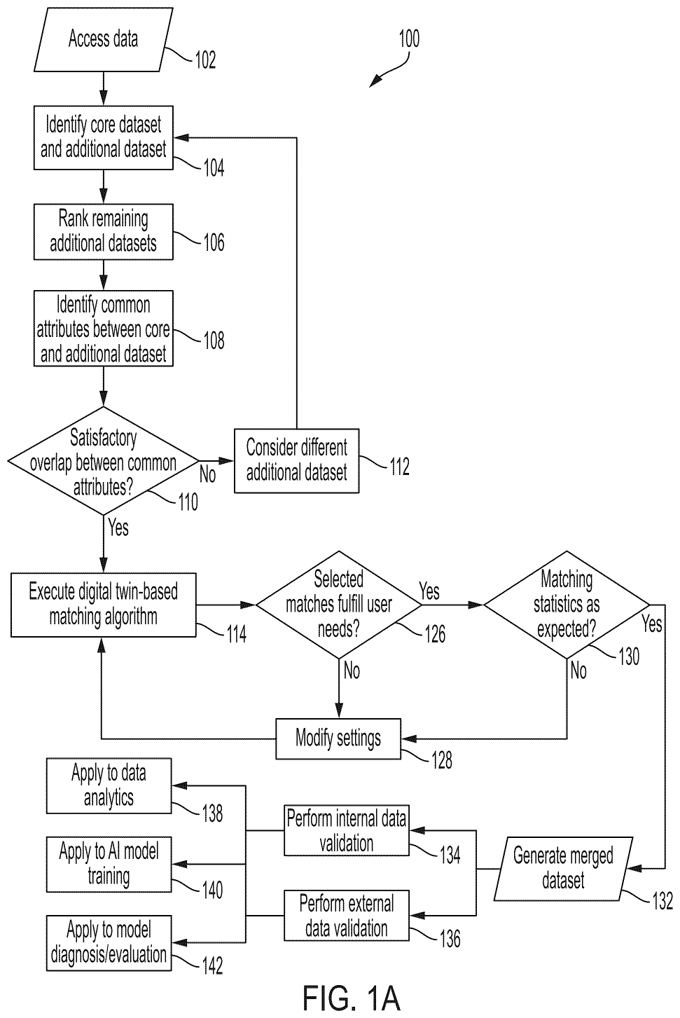

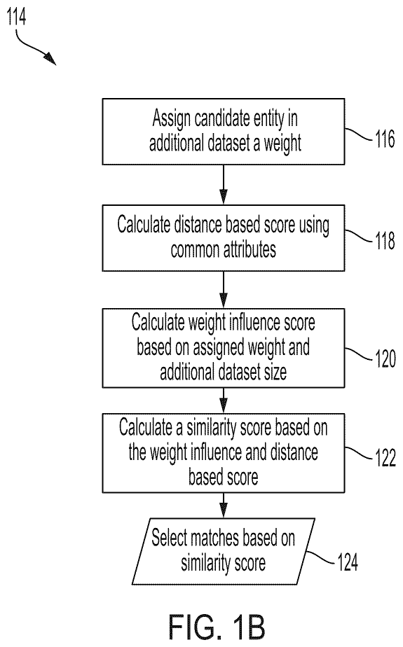

FIGS. 1A-1B illustrate process diagram 100 for generating a merged dataset from multiple data sources. As shown in FIG. 1A, at step 102, the system may access one or more data sources comprising multiple datasets. In some embodiments, one or more datasets may be publically available, and/or one or more datasets may be proprietary (e.g., private). In some embodiments, the accessed datasets may all be proprietary. In some embodiments, the accessed datasets may all be publicly available. In some embodiments, one or more datasets may comprise survey data of a sample population (e.g., subset). For example, a user may possess at least one proprietary dataset with a sample population's answers to a set of questions, wherein the set of questions translates to a set of attributes. The user may seek to gain insight on the relationship between these attributes and one or more attributes not included in the proprietary dataset. Thus, the user may provide to a system one or more datasets (e.g., public and/or private datasets) which comprise information on the one or more attributes of interest.

For example, a user may possess one or more proprietary datasets describing health behaviors, motivators, and barriers of a given population. The user may desire insight between these health behaviors, motivators and barriers, as well as health conditions and demographics not provided in the proprietary dataset. The user may prompt a system to access one or more public and/or private datasets detailing at least health conditions and demographic data of different populations. However, because the two datasets may not describe the same set of entities and may be derived from different data sources, an identical identifier between the datasets may not exist for direct data merging between the two or more datasets. Additional examples with other types of attributes are described in greater detail below.

At step 104, the system may identify a core dataset and an additional dataset in the plurality of datasets. In some embodiments, the dataset with the majority of the desired attributes and/or a larger volume (e.g., larger number of entities) may be designated as the core dataset. In the example above, a proprietary dataset comprising health behaviors and drivers (e.g., motivators) and barriers of health behaviors may be denoted as the core dataset. Any additional datasets which may comprise one or more attributes detailing at least demographics and health conditions may be denoted as additional datasets.

At step 106, in instances where more than one additional dataset exists, the system may receive an initial rank of the additional datasets for evaluation, the rank based on importance of the additional dataset(s) as perceived by a user. In some embodiments, each of the additional datasets may be associated with a numerical value indicative of a rank. In some embodiments, the system may receive a set of additional datasets in a specific order, the order corresponding to the rank. In some embodiments, the system may receive a plurality of additional datasets, as well as a separate indication of a ranking of the datasets. In some embodiments, the system may receive a set of additional datasets, and automatically rank the datasets based on one or more predefined criteria. For example, the datasets may be ordered based on number of entities and/or number of attributes.

For example, if a first additional dataset comprises one or more attributes detailing health behaviors most important to the user, the first additional dataset may be ranked above the remaining datasets. In the instance the secondary goal of merging datasets is to understand drivers of the health behaviors, a second additional dataset comprising a majority of health behavior drivers may be ranked second. Finally, a third additional dataset comprising attributes describing a set of entities with health behavior barriers may be ranked after the above described additional datasets, in the instance health behavior barriers are of the least importance to the user in comparison to drivers and types of health behaviors.

In some embodiments, a given dataset may comprise any combination of desired attributes. For example, a first additional dataset may comprise a first portion of health behaviors, as well as one or more drivers and/or barriers of the first portion of health behaviors. Furthermore, a second additional dataset may comprise a second portion of health behaviors, and optionally one or more drivers and/or barriers of the second portion of health behaviors. In some embodiments, each of the datasets may optionally be associated with information such as demographics and/or health conditions of a given population. However, the sampled population (e.g., subset) described by the attributes in each dataset may vary across all accessed datasets.

At step 108, the system may identify one or more common attributes between the core dataset and the first additional dataset in the rank of additional datasets. For example, each of the core dataset and first additional dataset may share attributes which describe a unique set of entities, such as age, gender, geographic location, employment status, income level, etc. Additional types of attributes depending on the type of dataset are described in greater detail in the examples provided below. The identified common attributes may be evaluated based on a set of predefined criteria to determine whether the set of common attributes has substantial overlap at step 110. For example, preliminary testing prior to deploying use of the algorithm may inform the user of an appropriate number of common attributes and/or an expected performance that will likely provide satisfactory data merging later in data analysis. In some embodiments, an appropriate number of attributes may be less than or equal to 5, 6, 7, 8, 9, or 10. In some embodiments, an appropriate number of common attributes may be greater than or equal to 5, 6, 7, 8, 9, or 10. For example, exploration and testing have indicated that a number of common attributes between 5 and 15 may be a suitable range for healthcare datasets. With such a setting, the disclosed method can identify at least one or more satisfactory matches for a majority of inquiring entities in the core dataset. In some embodiments, the performance of a given common attribute, such as a health condition (e.g., chronic obstructive pulmonary disorder, COPD) may have a higher expected performance than, for example, age and/or gender, in embodiments where the user is interested in a relationship between health-related attributes. Thus, common attributes that are perceived as more desirable to the user may lead to a better expected performance for the matching algorithm.

In the instance more than one additional dataset exists, and the common attributes identified between the first additional dataset and the core dataset do not satisfy the predefined criteria, at step 112, the system may consider a different dataset. For example, the system may consider a second additional dataset to identify common attributes with the core dataset. The ranking of the additional datasets may be modified to reflect the second additional dataset as the most important of the additional datasets. For example, the system may automatically restructure the order of evaluation of the plurality of datasets. In some embodiments, the system may receive modified ranking data from a user indicating an updated order of evaluation. The system may then identify a new set of common attributes between the core dataset and second additional dataset and assess whether the common attributes meet the one or more predefined criteria. The process of identifying a set of common attributes between a given additional dataset and the core dataset may repeated until a satisfactory overlap between the core dataset and an additional dataset is achieved.

At step 114 in FIG. 1A, the system may execute the digital twin-based merging algorithm between a given additional dataset and the core dataset. For example, in the instance the identified common attributes between the core dataset and the first additional dataset satisfy the predefined criteria, each candidate entity in the first additional dataset may be evaluated with the method to identify one or more matches for each inquiring entity in the core dataset. An inquiring entity may be defined as an entity in the core dataset that the system is seeking, or inquiring for, one or more matches. A candidate entity may be defined as an entity in the additional dataset(s) that may be an option, or candidate, for a match to one or more inquiring entities in the core dataset. In some embodiments, an entity in a dataset (e.g., core dataset and/or additional dataset) may represent an individual (e.g., person), or group of individuals (e.g., cohort, corporation, organization, etc.). For example, a dataset may represent a sample population (e.g., subset of data), wherein each entity in the dataset represents an individual in the sample population, and the sample population represents a larger population (e.g., superset of data). In some embodiments, each entity in a dataset may be a group of one or more similar individuals in a population, wherein the dataset comprises information for the complete population. Thus, rather than on an individual level, datasets may be merged using attributes which describe a cohort (or group of entities) from a dataset sharing one or more attributes.

The digital twin-based matching algorithm at step 114 may comprise a secondary process with one or more steps, illustrated in FIG. 1B. At step 116 in FIG. 1B, for a candidate entity in a given additional dataset, the matching algorithm comprises assigning the candidate entity a weight influence score at step 116. For example, in the instance the candidate entity is an individual from a sample population, the assigned weight influence score may be dependent on the individual's representativeness of a group of similar individuals within the whole population. Likewise, in the instance a candidate entity is a group of individuals (e.g., subset), the weight influence score may be indicative of the group's representativeness of a larger group of individuals (e.g., superset). The weight influence score quantifies a candidate entity's representativeness, and in some embodiments may be calculated for each entity within the additional dataset using example Equation 1 provided below. In some embodiments, the weight influence score may consider variables including the size of the population in an additional dataset, N, and the weight assigned to the candidate entity in the additional dataset, Wᵢ. The individual weight Wᵢ may be informed by raw data.

$$( 1 )$$

$$weight influence score = \frac{max ( {min}_{crop} , min ( {max}_{crop} , a * \frac{b * log ( N * {W}_{i} )}{1 + \vert b * log ( N * {W}_{i} ) \vert} + 1 ) )}{Normalization factor}$$

As shown, the weight assigned may be bound by one or more cropping functions, wherein min_{crop} is equal to 0 and max_{crop} is equal to 2, in accordance with some embodiments. The cropping functions may limit the contribution of an entity weight to the matching score to a predefined upper limit (e.g., a value of 2). For example, an initial value may be computed using constants a and b, which in some embodiments are equal to 3 and 0.1, respectively, as well the logarithm of the weight multiplied by the population size. The determined value may be compared to the max_{crop} (e.g., 2), and the minimum of the two values may be selected and compared to the min_{crop} (e.g., 0). Then, the maximum of the two values may be selected and normalized, as described below, to determine a weight influence score for the candidate entity.

$$Normalization factor = a * \frac{b * log ( N )}{1 + b * log ( N )} + 1 \qquad ( 2 )$$

In some embodiments, determining a weight influence may include normalization of the weight using a normalization factor, which in some embodiments may be determined as shown above in Equation 2. In some embodiments, parameters a and b may be constants in calculating the normalization factor, wherein a may be equal to 3, and b may be equal to 0.1. The empirical values of parameters a and b may be flexible, and the default setting of these parameters may be appropriate to applications in different industries. The normalization factor may be determined at least in part by using the logarithm of the population size, N. The default parameters that may be used in the weight influence score and normalization factor, including a, b, min_{crop}, and max_{crop}, may be optimized for a specific application of the algorithm using preliminary testing to understand what parameters provide most accurate results prior to deploying the algorithm for use. In some embodiments, preliminary testing may include mapping various combinations of parameter values to their corresponding performance of dataset merging.

In some embodiments, one or more of the weight influence score and normalization factor may be determined in a manner different from the equations provided above. In some embodiments, a candidate entity may not be from a sample population of a larger population. Thus, the assigned weight may by default be 0, and the digital-twin based matching algorithm may proceed without a weight influence score. In some embodiments, a user may decide in executing the matching method whether or not to include sample weights to the algorithm, which may provide generalization and flexibility in using the model.

At step 118, a candidate entity within the additional dataset may additionally be assigned a distance-based score. The distance-based score may be based at least in part on the common attributes identified between the additional dataset and the core dataset. In some embodiments, the distance-based score may be determined using Equation 3 shown below. In some embodiments, the attribute data describing a candidate entity may match directly with attribute data of the inquiring entity from the core dataset, and thus the candidate entity may be assigned a weighted Manhattan distance of 0. Thus, a maximum distance-based score of 1 is achieved when there is an exact match between an inquiring entity and candidate entity. On the other hand, in instances where there is variation between the attributes in the core dataset and the additional dataset, the variation may be accounted for in the weighted Manhattan distance. In some embodiments, the variation of data may be measured using one or more of a Hamming, Euclidean, or Minkowski distance, in addition to or in place of a Manhattan distance. By differentiating between exact matches and matches with variation, computational time in the digital twin-based matching algorithm may be reduced.

$$distance based score = \frac{1}{( 1 + Weighted Manhattan distance )} \qquad ( 3 )$$

At step 120, a similarity score for the candidate entity may be determined using at least the calculated distance-based score and weight influence score. For example, the similarity score may be calculated as shown below with regards to Equation 4. The matching score may additionally be based on a fraction parameter, wherein the fraction may be equal to 0.9. In some embodiments, fraction may be any number greater than 0.5 and less than 1. For example, the parameter fraction may be less than or equal to 0.6, 0.7, 0.8, and 0.9, and greater than 0.5. In some embodiments, the parameter fraction may be greater than or equal to 0.6, 0.7, 0.8, and 0.9, and less than 1. With a fraction greater than 0.5, the distance-based score has a larger influence on the determined matching score than the weight influence score. In some embodiments, the relationship between the distance-based score and weight influence score may be additive, which may be determined from preliminary testing (similar to as described above with respect to the parameters in the weight influence score).

Matching score=fraction*distance based score+(1−fraction)*(weight influence score) (4)

The distance-based score, weight influence score, and matching score may be determined for each candidate entity in the additional dataset compared to an inquiring entity (e.g., individual of interest) in the core dataset, such that each inquiring entity in the core dataset is assessed against the entire additional dataset. In some embodiments where sample weights are not assigned to the candidate entities, the matching score for each candidate entity may be derived from only a distance-based score, with no influence from a weight influence score. Using the determined set of similarity scores, one or more candidate entities in the additional dataset may be selected as a match for the inquiring entity in the core dataset at step 124 in FIG. 1B. For example, the algorithm may determine a one-to-one match for each inquiring entity in the core dataset, or, in accordance with another embodiment, a one-to-many match for each inquiring entity in the core dataset. In some embodiments, the candidate entities in the additional dataset may be ranked based on the determined similarity scores to determine the top N matches (wherein N may be any number) for an inquiring entity. In some embodiments, a percentage of candidate entities may be selected. For example, greater than or equal to the top 1%, 2%, 3%, 4%, or 5% of candidate entities may be selected as matches for an inquiring entity in the core dataset. In some embodiments, less than or equal to the top 1%, 2%, 3%, 4%, or 5% of candidate entities may be selected as matches for a given inquiring entity of the core dataset. In some embodiments, each candidate entity which exceeds a threshold similarity score may be selected. For example, a similarity score threshold may be between 0.8 and 1, such as 0.8, 0.9, 0.95, 0.98, and 1. In some embodiments, the score threshold may be less than 0.8.

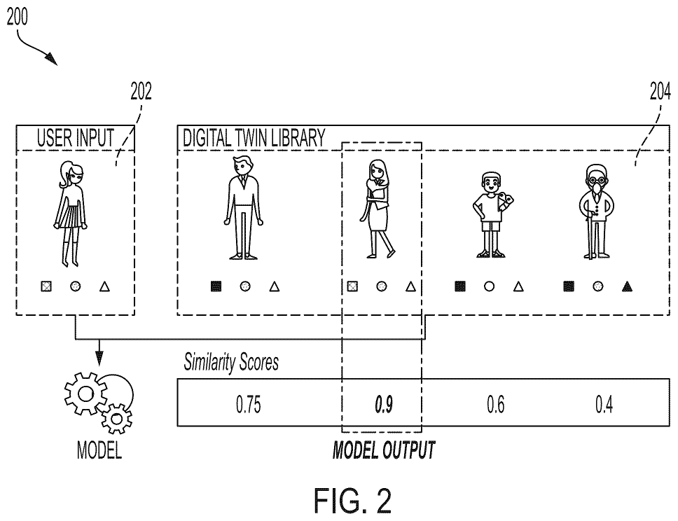

For example, with reference to FIG. 2, a given inquiring entity 202 in the core dataset may be described by a plurality of attributes. For illustrative purposes, the attributes are demonstrated as shapes (e.g., square, circle, triangle), and the inquiring entity 202 and candidate entities 204 are illustrated as individuals (e.g, individual people). Each candidate entity 204 in the additional dataset may be compared to the inquiring entity 202 using the matching algorithm. For illustrative purposes, only 4 candidate entities are demonstrated in the additional dataset, however, the dataset may comprise an unlimited number of candidate entities, and in some embodiments, each candidate entity in the additional dataset may be compared to the inquiring entity of the core dataset. Each of the 4 illustrated candidate entities 204 in the additional dataset may be described by attributes in common with the inquiring entity 202. For example, the common attributes may be at least gender, age, and occupation. Each unique characteristic of the inquiring entity 202 and candidate entities 204 with relation to the three or more attributes may contribute to the similarity score determined using the matching method.

For example, the inquiring entity 202 of interest may be a female educator within the age of 18-25. The first candidate entity 204 may be a male educator in the age range of 18-25, the second candidate entity may be a female educator in the age range of 18-25, the third candidate entity may be a male student in the age range of 10-15, and the fourth candidate entity 204 may be a male accountant in the age range of 50-60. Thus, the four candidate entities 204 in comparison to the inquiring entity 202 may be assigned similarity scores of 0.75, 0.9, 0.6, and 0.4, respectively. In some embodiments, the second candidate entity in the additional dataset may be selected as the only match to the target entity 202 of the four illustrated candidate entities because the entity 204 satisfies the criteria (e.g., similarity score is above a threshold). In some embodiments, additional attributes that may differ between the inquiring entity 202 and each of the candidate entities 204 may additionally contribute to the similarity score, and are not illustrated in FIG. 2 for simplicity.

Thus, the attribute data associated with the second candidate entity 204 in the additional dataset may be associated with the attribute data describing the inquiring entity 202 in the core dataset to generate a merged dataset. For example, the attribute data of the inquiring entity 202 and the second candidate entity 204 may be aggregated to a new dataset. In some embodiments, the attribute data of second candidate entity 204 may be added to the existing core dataset.

Returning to FIG. 1A, at step 126, each of the selected matches may be evaluated to determine whether the user's needs are fulfilled. For example, the system may analyze similarity score data using one or more rulesets and/or models to determine whether one or more satisfaction criteria are met. In some embodiments, satisfaction criteria may include the number of matches with similarity scores above a predefined threshold. Users may also evaluate the matching at each common attribute for each selected match to determine whether the common attributes provide appropriate contributions to the determined similarity scores. In the instance the user's needs are not satisfied, one or more settings of the digital twin-based matching algorithm may be modified at step 128. For example, one or more of the parameters described above related to the distance-based score, weight influence score, and matching score may be modified, and the method may be repeated to determine one or more new matches between the core dataset and the additional dataset. In some embodiments, the method with which one or more of the distance-based score, weight influence score, and matching score may be revised.

In the instance the evaluated matches are satisfactory, at step 130, the system may then assess whether the distribution of matching statistics is satisfactory. For example, the system may evaluate whether the matching results between the core and additional dataset produces an even distribution, such as one which resembles a bell curve on a graphical representation of the similarity score data. In some embodiments, the confidence of the merging algorithm may additionally be evaluated at least in part using the quantified matching results between the core dataset and each additional dataset. Additionally, whether an acceptable similarity score threshold is satisfied for a majority of matches may be assessed. In some embodiments, the threshold may be defined by a user. In some embodiments, the threshold may be dynamically selected by the system. For example, an acceptable score threshold may be between 0.8 and 1, such as 0.8, 0.9, 0.95, 0.98, and 1. In some embodiments, the score threshold may be less than 0.8. In embodiments where a top percentage of matches from an additional dataset are selected for an inquiring entity in the core dataset, whether the matches within the percentage meet one or more predefined criteria may be assessed. In the instance the statistics are deemed unsatisfactory, the system may modify one or more algorithm settings, such as searching and selection settings and/or those described above. The digital twin-based matching method may be executed again for the set of candidate entities in the additional dataset compared with an inquiring entity in the core dataset.

Once it is determined that the matching statistics meet the predefined criteria, a merged dataset may be generated at step 132. For example, the attribute data for a candidate entity from the additional dataset selected to be a match may be merged (e.g., joined) to the attribute data of the corresponding inquiring entity in the core dataset. In some embodiments, the attribute data of the one or more selected matches from the additional dataset and the attribute data of the inquiring entities in the core dataset for which one or more matches were identified may be added to a new dataset.

Following merging a first additional dataset to the core dataset, in embodiments where more than one additional dataset was provided to the system, each subsequent additional dataset may be evaluated for matches using the digital-twin based algorithm. For example, the process of identifying a set of common attributes between the updated core dataset (e.g., merged core and first additional dataset) and an additional dataset may be repeated to determine a second additional dataset to evaluate using the digital-twin matching algorithm. The ranking data of the remaining additional datasets may be manipulated to determine an additional dataset which meets the predefined criteria for the algorithm, as described above. In some embodiments, the predefined criteria may be modified for each subsequent additional dataset (e.g., the expected performance and/or the number of common attributes required to execute the matching algorithm may decrease).

In some embodiments, the initial determined ranking data of the plurality of additional datasets prior to execution of the first selected additional dataset with the digital-twin based algorithm may be used to sequentially assess each additional dataset. Thus, it may not be necessary to identify common attributes between the core dataset and other additional datasets prior to executing the matching algorithm for the remainder of the additional datasets. In some embodiments, the method of identifying common attributes and/or executing the digital-twin based algorithm may be repeated until each additional dataset of interest has been analyzed. In some embodiments, the digital-twin based matching algorithm may be repeated until a set of predefined criteria for the resultant merged algorithm is met. In this instance, only a portion of the originally received additional datasets may be assessed for matches to the core dataset. The resultant outcome may be a comprehensive synthetic, merged dataset comprising the core dataset and each of the matches (e.g., selected candidate entities) from the additional datasets. In some embodiments, the resultant outcome is a new dataset comprising only the attribute data of the inquiring entities from the core dataset that had matches identified from the additional datasets, and the attribute data of the selected matches from the additional datasets.

Following generation of a comprehensive synthetic dataset, the dataset may be validated using one or more means of validation. For example, at step 134, the dataset may be validated internally using methods such as cross-validation, which may validate the relationships between original attributes and additional attributes. In some embodiments, external validation of the dataset may additionally be performed using new data at step 136. In some embodiments, external (e.g., new) data which may be relevant to the generated synthetic dataset may be inputted to the model and compared with the dataset. For example, the system may validate whether the entities in the synthetic dataset described by the comprehensive set of attributes are aligned with one or more entities in an external dataset.

The merged data once validated may be utilized in a variety of applications, including data analytics (138), artificial intelligence (AI) model training (140), and/or model diagnosis/evaluation (142). For example, the synthetic dataset may be used as training data in a machine learning model to make predictions, which is described in greater detail in the examples provided below. Using the enriched synthetic data in the machine learning model may allow the model to make more meaningful and/or accurate predictions. In another embodiment, the synthetic data may be analyzed to identify one or more inquiring entities (e.g., individual customers, customer segments, etc.) in the core dataset for a given product and/or service. Additionally, synthetic data may be applied in various industries to improve and scale AI use cases.

### Example Use Cases of the Digital Twin-Based Merging Algorithm

The merging algorithm will now be described by way of example applications of the model. In one example application of the digital-twin based merging algorithm, a user may be interested in determining a relationship between health behaviors, their motivators and barriers, demographics, and health conditions. For example, a user may possess a proprietary dataset comprising health behaviors, motivators, and barriers describing a given population. The attributes may include one or more of fruit, vegetable, and soda consumption, alcohol and tobacco use, and exercise habits, preferred contact frequency by a healthy-living program through different channels (e.g., social media platforms, email, text message), motivators to change health habits (e.g., goal-setting, dieting, etc.), importance of different activities on health, barriers to managing health, etc. The proprietary dataset may also comprise limited demographic and/or health condition data, such as age, gender, ethnicity, employment, etc.

One or more publicly available datasets comprising at least demographic and health condition data may be identified, which may be from different sources and related to different populations. For example, a dataset comprising attributes such as risk and/or presence of one or more diseases and health conditions (e.g., stroke, cancer, asthma, arthritis, Alzheimer's disease, chronic kidney disease (CKD), cardiovascular disease (CVD), chronic obstructive pulmonary disorder (COPD), etc.) and demographics (e.g., age, gender, language spoken, race, education level, income status, geographic location, etc.) may be accessed. The core dataset may be identified as the dataset comprising a majority of the attributes of interest (e.g., the health behaviors attributes), and the additional dataset may be identified as that with the majority of demographics and health condition information.

Common attributes between the core and additional dataset may be identified, such as age, gender, language spoken, ethnicity/race, education level, employment status, income, blood pressure, presence of chronic obstructive pulmonary disorder (COPD), presence of cardiovascular disease (CVD), and presence of diabetes. Using at least the set of common attributes, the two datasets may be successfully merged, as described in greater detail above. The synthetic dataset may be applied in data analytics to, for example, gain insights to a patient subpopulation regarding digital therapeutics and evaluate customer reach programs. For example, an end-user may identify one or more demographics which are least receptive to a specific form of reach from a healthy-living program and use this finding to strategize tactics to improve reach. In another example, an end-user may draw conclusions between one or more health conditions and current health behaviors of a patient subpopulation to identify comorbidities, or prevent occurrence of a disorder or disease.

In another example application of the algorithm, the digital-twin based merging algorithm may be applied to merge financial information of a first set of entities with health condition and demographic data. In some embodiments, a first proprietary dataset comprising financial information may be identified as the core dataset, comprising attributes such as income level, financial assets (e.g., stocks, bonds, mutual funds, etc.), home ownership, retirement funds, insurance information, etc. An additional proprietary dataset may be identified which details health information and demographics, such as existing health conditions (e.g., those described above with regards to the first example) and demographics such as age, gender, location, ethnicity, etc.

A common set of attributes between the two datasets may include age, gender, ethnicity, language spoken, family size, marital status, income, home ownership, and occupation. Using at least the set of common attributes, a merged synthetic dataset which provides insight to the relationship between demographics, health conditions, and financial status may be generated using the digital twin-based merging method. In some embodiments, the synthetic dataset may be applied as training data in a machine learning (ML) model for making predictions. For example, the synthetic data may be applied in a classification ML model using methods such as random forest, logistic regression, decision tree, K-nearest neighbors, gradient-boosted tree (e.g., XGBoost), etc.

In an additional application of the digital-twin based merging algorithm, a user may possess a set of financial information for a given set of entities, or in this example, individuals. For example, the dataset may comprise limited insight to the set of individuals' financing with a given bank (e.g., checking account and savings account information), as well as limited demographic information. A user may seek to gain insight on the relationship between the core dataset financial attributes and additional financial attributes, such as insurance information (e.g., health insurance, life insurance, car insurance, etc.), financial assets (e.g., mortgage, stocks, mutual funds, bonds, etc.), etc. Thus, the user may retrieve one or more additional datasets which comprises the attributes of interest, as well as one or more attributes which are common with the core dataset (e.g., demographic information) to determine a relationship between various financial attributes that were previously associated with different populations. In some embodiments, the merged synthetic dataset may be applied to inform a user of a target population of customers for a given financial service.

### Method for Digital Twin-Based Data Merging

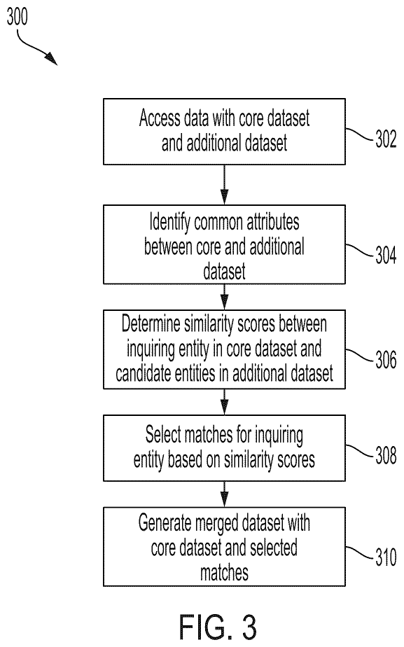

FIG. 3 illustrates method diagram 300 for generating a merged dataset from a core dataset and an additional dataset, in accordance with some embodiments. At step 302, a system may access data comprising a core dataset and at least one additional dataset. The core dataset may be identified as the dataset which comprises the majority of attributes of interest to a user and/or describes a larger number of entities. At step 304, the system may identify a plurality of common attributes between the core and additional dataset. For example, each dataset may describe a unique set of entities with one or more attributes, such as age, gender, and/or geographic location.

At step 306, the system may determine a similarity score for each candidate entity in the additional dataset in comparison to an inquiring entity in the core dataset. The similarity score for a candidate entity may be based at least in part on a weight influence score and distance-based score calculated for the candidate entity. In some embodiments, the weight influence score is dependent upon the candidate entity's representativeness of a group of similar entities in the population. In some embodiments, the distance-based score is based on the plurality of common attributes identified between the core and additional dataset, accounted for in a weighted Manhattan distance.

At step 308, the system may select one or more matches for each inquiring entity in the core dataset based on the determined similarity scores for each candidate entity in the additional dataset. For example, selecting one or more matches may be based on whether the statistical distribution of similarity scores and the plurality of similarity scores meet the predefined criteria. At step 310, a merged dataset comprising the core dataset and one or more selected candidate entities (e.g., matches) from the additional dataset may be generated. In instances with more than one additional dataset, the process may be repeated between the updated core dataset and each additional dataset to create a comprehensive synthetic dataset.

### Systems for Digital Twin-Based Data Merging

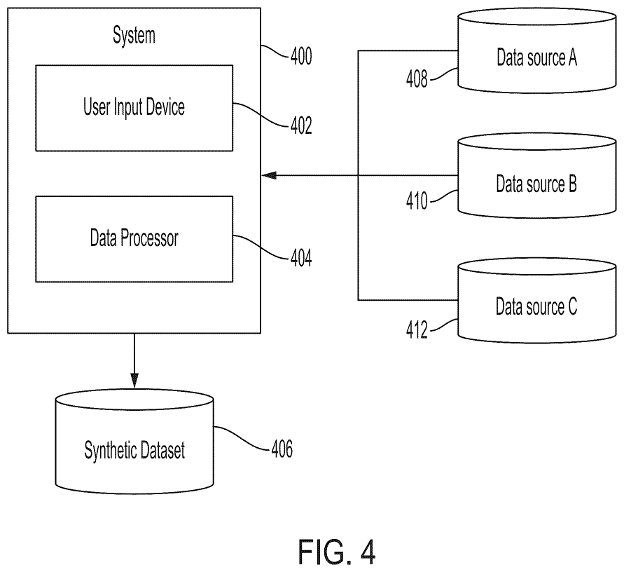

FIG. 4 illustrates a system 400 for executing a digital twin-based merging algorithm, such as method 300 described with respect to FIG. 3, in accordance with some embodiments. System 400 may comprise a user input device 402 and data processor 404. System 400 may be configured to receive inputs from one or more databases and/or data sources 408, 410, and 412. For example, data source 408 may comprise a core dataset, as described above, and data sources 410 and 412 may comprise a plurality of additional datasets to be evaluated and merged with the core dataset to create a synthetic dataset 406. In some embodiments, data source 408 may comprise a core dataset and one or more additional datasets to be merged. In some embodiments, user input device 402 may be configured to enable a user to modify one or more features of the data merging algorithm executed by system 400. For example, a user may modify one or more settings described above with respect to FIG. 1A in the instance the selected matches do not fulfill the user's needs and/or the matching statistics are not satisfactory. In some embodiments, user input device 402 may be a display configured to provide the matching results to an end-user. In some embodiments, data processor 404 may be configured to receive and process data from the one or more sources 408, 410, and/or 412. Data processor 404 may provide a synthetic dataset 406 for further data analysis, such as that described with regards to 138, 140, and 142 in FIG. 1A above. In some embodiments, a synthetic merged dataset may be transmitted from data processor 402 to any one or more of data sources 408, 410, and 412.

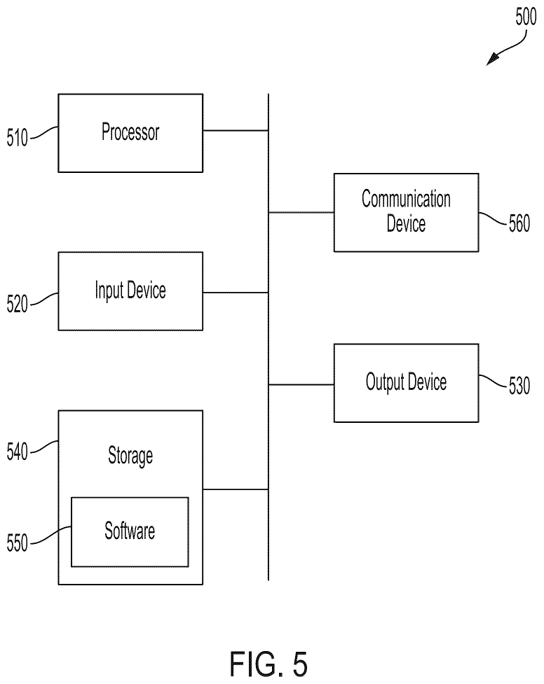

FIG. 5 illustrates an example of a computing system 500, in accordance with some examples of the disclosure. System 500 can be a client or a server. As shown in FIG. 5, system 500 can be any suitable type of processor-based system, such as a personal computer, workstation, server, handheld computing device (portable electronic device) such as a phone or tablet, or dedicated device. The system 500 can include, for example, one or more of input device 520, output device 530, one or more processors 510, storage 540, and communication device 560. Input device 520 and output device 530 can generally correspond to those described above and can either be connectable or integrated with the computer.

Input device 520 can be any suitable device that provides input, such as a touch screen, keyboard or keypad, mouse, gesture recognition component of a virtual/augmented reality system, or voice-recognition device. Output device 530 can be or include any suitable device that provides output, such as a display, touch screen, haptics device, virtual/augmented reality display, or speaker.

Storage 540 can be any suitable device that provides storage, such as an electrical, magnetic, or optical memory including a RAM, cache, hard drive, removable storage disk, or other non-transitory computer readable medium. Communication device 560 can include any suitable device capable of transmitting and receiving signals over a network, such as a network interface chip or device. The components of the computing system 500 can be connected in any suitable manner, such as via a physical bus or wirelessly.

Processor(s) 510 can be any suitable processor or combination of processors, including any of, or any combination of, a central processing unit (CPU), field programmable gate array (FPGA), and application-specific integrated circuit (ASIC). Software 550, which can be stored in storage 540 and executed by one or more processors 510, can include, for example, the programming that embodies the functionality or portions of the functionality of the present disclosure (e.g., as embodied in the devices as described above)

Software 550 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate embodiments; however, it will be appreciated that the scope of the disclosure includes embodiments having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for generating a merged dataset, the method comprising:
accessing data comprising a core dataset and an additional dataset;
identifying a plurality of common attributes between the core dataset and the additional dataset;
determining a plurality of similarity scores between an inquiring entity in the core dataset and a plurality of candidate entities in the additional dataset, including, for each candidate entity of the plurality of candidate entities:
calculating a distance-based score for the candidate entity based at least in part on one or more of the plurality of identified common attributes;
calculating a weight influence score for the candidate entity based at least in part on a weight assigned to the candidate entity; and
calculating a similarity score for the candidate entity based at least in part on the distance-based score and the weight influence score;
selecting one or more matches for the inquiring entity in the core dataset from the plurality of candidate entities in the additional dataset based at least in part on the plurality of similarity scores; and
generating the merged dataset by adding the one or more selected matches for the inquiring entity to the core dataset.

2. The method of claim 1, comprising, prior to determining the plurality of similarity scores, evaluating the plurality of common attributes to determine that the plurality of identified common attributes satisfies one or more predefined criteria.

3. The method of claim 2, wherein the one or more predefined criteria are related to an expected performance of a given attribute and/or an appropriate number of common attributes.

4. The method of claim 1, wherein generating the merged dataset includes determining that one or more of the calculated similarity scores between the inquiring entity and the plurality of candidate entities in the additional dataset exceeds a predefined score threshold.

5. The method of claim 1, comprising, prior to generating the merged dataset, evaluating the confidence and/or distribution of the one or more selected matches for the inquiring entity.

6. The method of claim 1, wherein the core dataset is accessed via a first data source and the additional dataset is accessed via a second data source.

7. The method of claim 1, wherein the core dataset and additional dataset do not share an identical identifier for direct dataset merging.

8. The method of claim 1, wherein the additional dataset is a subset of a superset, and wherein the weight assigned to the candidate entity in the subset is based on representativeness of a group of similar entities in the superset.

9. The method of claim 1, wherein calculating the distance-based score is based on a weighted Manhattan distance.

10. The method of claim 1, wherein calculating the weight influence score includes normalization and bounding the weight assigned to the candidate entity with at least one cropping function.

11. The method of claim 1, wherein the weight influence score is based on a size of the additional dataset.

12. The method of claim 1, comprising validating the merged dataset using one or more of: internal validation and external validation.

13. The method of claim 1, comprising applying the merged dataset to one or more of: a data analytics operation, an artificial intelligence (AI) model training operation, a model diagnosis operation, and a model evaluation technique.

14. A non-transitory computer-readable storage medium storing one or more programs for generating a merged dataset, the programs for execution by one or more processors of an electronic device that when executed by the device, cause the device to:
access data comprising a core dataset and an additional dataset;
identify a plurality of common attributes between the core dataset and the additional dataset;
determine a plurality of similarity scores between an inquiring entity in the core dataset and a plurality of candidate entities in the additional dataset, including, for each candidate entity of the plurality of candidate entities:
calculate a distance-based score for the candidate entity based at least in part on one or more of the plurality of identified common attributes;
calculate a weight influence score for the candidate entity based at least in part on a weight assigned to the candidate entity; and
calculate a similarity score for the candidate entity based at least in part on the distance-based score and the weight influence score;
select one or more matches for the inquiring entity in the core dataset from the plurality of candidate entities in the additional dataset based at least in part on the plurality of similarity scores; and
generate the merged dataset by adding the one or more selected matches for the inquiring entity to the core dataset.

15. A system for generating a merged dataset, comprising:
one or more processors; memory; and one or more programs stored on the memory that when executed by the one or more processors cause the one or more processors to:
access data comprising a core dataset and an additional dataset;
identify a plurality of common attributes between the core dataset and the additional dataset;
determine a plurality of similarity scores between an inquiring entity in the core dataset and a plurality of candidate entities in the additional dataset, including, for each candidate entity of the plurality of candidate entities:
calculate a distance-based score for the candidate entity based at least in part on one or more of the plurality of identified common attributes;
calculate a weight influence score for the candidate entity based at least in part on a weight assigned to the candidate entity; and
calculate a similarity score for the candidate entity based at least in part on the distance-based score and the weight influence score;
select one or more matches for the inquiring entity in the core dataset from the plurality of candidate entities in the additional dataset based at least in part on the plurality of similarity scores; and
generate the merged dataset by adding the one or more selected matches for the inquiring entity to the core dataset.

16. A method for generating a merged dataset, the method comprising:
accessing data comprising a core dataset and a plurality of additional datasets;
determining ranking data of the plurality of additional datasets;
selecting a first additional dataset of the plurality of additional datasets based on the ranking data;
identifying a plurality of common attributes between the core dataset and the first additional dataset;
in accordance with determining that the plurality of identified common attributes satisfy one or more predefined criteria, selecting one or more matches for each inquiring entity in the core dataset from a plurality of candidate entities in the first additional dataset; and
generating the merged dataset by adding the one or more selected matches to the core dataset.

17. The method of claim 16, comprising, in accordance with determining that the plurality of common attributes between the core dataset and the first additional dataset do not satisfy the one or more predefined criteria, modifying the ranking data of the plurality of additional datasets.

18. The method of claim 17, comprising:
selecting a second additional dataset of the plurality of additional datasets based on the modified ranking data; and
identifying a plurality of common attributes between the core dataset and the second additional dataset.

19. The method of claim 18, comprising, in accordance with determining that the second plurality of identified common attributes satisfies the one or more predefined criteria, selecting one or more matches for each inquiring entity in the core dataset from a plurality of candidate entities in the second additional dataset.

20. The method of claim 19, comprising generating the merged dataset by adding the one or more selected matches to the core dataset.

21. The method of claim 16, wherein selecting the one or more matches for each inquiring entity in the core dataset comprises determining a plurality of similarity scores between the inquiring entity and each candidate entity of the plurality of candidate entities in the first additional dataset.

22. The method of claim 21, wherein determining a similarity score for the candidate entity of the plurality of candidate entities is based at least in part on a distance-based score calculated based at least in part on one or more of the plurality of identified common attributes between the core dataset and the first additional dataset.

23. The method of claim 21, wherein determining a similarity score for the candidate entity of the plurality of candidate entities is based at least in part on a weight influence score calculated based at least in part on a weight assigned to the candidate entity.

24. A non-transitory computer-readable storage medium storing one or more programs for generating merged datasets, the programs for execution by one or more processors of an electronic device that when executed by the device, cause the device to:
access data comprising a core dataset and a plurality of additional datasets;
determine ranking data of the plurality of additional datasets;
selecting a first additional dataset of the plurality of additional datasets based on the ranking data;
identify a plurality of common attributes between the core dataset and the first additional dataset;
in accordance with determining that the plurality of identified common attributes satisfy one or more predefined criteria, select one or more matches for each inquiring entity in the core dataset from a plurality of candidate entities in the first additional dataset; and
generate the merged dataset by adding the one or more selected matches to the core dataset.

25. A system for generating merged datasets, comprising:
one or more processors; memory; and one or more programs stored on the memory that when executed by the one or more processors cause the one or more processors to:
access data comprising a core dataset and a plurality of additional datasets;
determine ranking data of the plurality of additional datasets;
select a first additional dataset of the plurality of additional datasets based on the ranking data;
identify a plurality of common attributes between the core dataset and the first additional dataset;
in accordance with determining that the plurality of identified common attributes satisfy one or more predefined criteria, select one or more matches for each inquiring entity in the core dataset from a plurality of candidate entities in the first additional dataset; and
generate the merged dataset by adding the one or more selected matches to the core dataset.
